(19) United States
(12) Patent Application Publication
(10) Pub. No.: US 2024/0038962 A1
(43) Pub. Date: Feb. 1, 2024

(54) PRE-LITHIATING POROUS LAYER FOR ELECTROCHEMICAL CELL AND METHODS OF FORMING THE SAME

(71) Applicant: GM GLOBAL TECHNOLOGY OPERATIONS LLC, Detroit, MI (US)

(72) Inventors: Xingcheng XIAO, Troy, MI (US); Sherman H. ZENG, Troy, MI (US); Meinan HE, Birmingham, MI (US)

(73) Assignee: GM GLOBAL TECHNOLOGY OPERATIONS LLC, Detroit, MI (US)

(21) Appl. No.: 17/875,328

(22) Filed: Jul. 27, 2022

(51) Int. Cl. H01M 4/131; H01M 4/1391

(52) U.S. Cl. CPC H01M 4/131; H01M 4/1391; H01M 2004/021

(57) ABSTRACT

An electrochemical cell is provided that includes a first electrode, a second electrode, a separating layer that physically separates the first and second electrodes, and a porous layer disposed between the separating layer and the first electrode. The porous layer includes a porous material having a plurality of pores and a lithiating material that at least partially fills the pores of the plurality. The porous layer can be a continuous coating disposed on a surface of the separating layer opposing the first electrode or a continuous coating disposed on a surface of the first electrode opposing the separating layer. The porous material can include zeolites, aerogels, silicon oxides, porous aluminum oxides, titanium oxides, manganese oxides, and/or magnesium oxides. The lithiating material can include lithium peroxide and can fill between about 30 and about 60% of the pores of the porous material.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium, which is oxidized into lithium ions releasing electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

In various instances, however, a portion of the intercalated lithium remains with the negative electrode following the first cycle due to, for example, conversion reactions and/or the formation of a solid electrolyte interphase (SEI) layer on the negative electrode during the first cycle, as well as ongoing lithium loss due to, for example, continuous solid electrolyte interphase breakage. Such permanent loss of lithium ions may result in a decreased specific energy and power in the battery resulting from, for example, added positive electrode mass that does not participate in the reversible operation of the battery. For example, the lithium-ion battery may experience an irreversible capacity loss of greater than or equal to about 5% to less than or equal to about 30% after the first cycle, and in the instance of silicon-containing negative electrodes, or other volume-expanding negative electroactive materials (e.g., tin (Sn), aluminum (Al), germanium (Ge)), an irreversible capacity loss of greater than or equal to about 20% to less than or equal to about 40% after the first cycle.

Current methods to compensate for first cycle lithium loss include, for example, electrochemical processes where a silicon-containing anode is lithiated using an electrolyte bath. However, such processes are susceptible to electrolyte pollution, and as a result, instability. Another method of compensation includes, for example, in-cell lithiation, which includes adding lithium to a cell. Such processes, however, require the use of mesh current collectors, which have high material costs, as well as coating costs. Yet another method of compensation includes, for example, the deposition (e.g., spraying or extrusion or physical vapor deposition (PVD)) of lithium on an anode or anode material. However, in such instances, it is difficult (and costly) to produce evenly deposited lithium layers. Accordingly, it would be desirable to develop improved electrodes and electroactive materials, and methods of using the same, that can address these challenges.

### SUMMARY

This section provides a general summary of the disclosure, and is not a comprehensive disclosure of its full scope or all of its features.

The present disclosure relates to an electrochemical cell including a pre-lithiating, porous layer disposed near or adjacent to one or more surfaces of the separator, and to methods of making and using the same.

In various aspects, the present disclosure provides an electrochemical cell that cycles lithium ions. The electrochemical cell may include a first electrode that includes a positive electroactive material, a second electrode that includes a negative electroactive material, a separating layer that physically separates the first electrode and the second electrode, and a porous layer disposed between the separating layer and the first electrode. The porous layer may include a porous material having a plurality of pores and a lithiating material at least partially filling the pores of the plurality.

In one aspect, the porous layer may be a continuous coating disposed on a surface of the separating layer opposing the first electrode.

In one aspect, the porous layer may be a continuous coating disposed on a surface of the first electrode opposing the separating layer.

In one aspect, the porous material may have a porosity greater than or equal to about 5 vol. % to less than or equal to about 90 vol. %, and the lithiating material may fill greater than or equal to about 30% to less than or equal to about 60% of the porosity of the porous material.

In one aspect, the porous material may be selected from the group consisting of: zeolites, aerogels, silicon oxides, porous aluminum oxides, titanium oxides, manganese oxides, magnesium oxides, and combinations thereof.

In one aspect, the lithiating material may include lithium peroxide (Li₂O₂).

In one aspect, the porous layer may have an average thickness greater than or equal to about 50 nanometers to less than or equal to about 50 micrometers.

In various aspects, the present disclosure provides an electrochemical cell that cycles lithium ions. The electrochemical cell may include a first electrode that includes a positive electroactive material, a second electrode that includes a negative electroactive material, a separating layer that physically separates the first electrode and the second electrode, and a porous layer disposed between the separating layer and the first electrode. The porous layer may include a porous material having a plurality of pores. For example, the porous material may have a porosity of greater than or equal to about 20 vol. % to less than or equal to about 100 vol. %. A lithiating material including lithium peroxide (Li₂O₂) may at least partially fill the plurality of pores.

In one aspect, the porous layer may be a continuous coating disposed on a surface of the separating layer opposing the first electrode.

In one aspect, the porous layer may be a continuous coating disposed on a surface of the first electrode opposing the separating layer.

In one aspect, the lithiating material may fill greater than or equal to about 30% to less than or equal to about 60% of the porosity of the porous material.

In one aspect, the porous material may be selected from the group consisting of: zeolites, aerogels, silicon oxides, porous aluminum oxides, titanium oxides, manganese oxides, magnesium oxides, and combinations thereof.

In one aspect, the porous layer may have an average thickness greater than or equal to about 50 nanometers to less than or equal to about 50 micrometers.

In various aspects, the present disclosure provides a method for preparing a pre-lithiating, porous layer for an electrochemical cell that cycles lithium ions. The method may include contacting a porous material having a plurality of pores and a precursor solution such that the precursor solution at least partially fills the plurality of pores. The precursor solution may include a lithium precursor and an aqueous solvent. The method may further include removing the aqueous solvent so as to form a lithiated precipitate in at least a portion of the plurality of pores so as to form the pre-lithiating, porous layer.

In one aspect, the lithium precursor may be selected from the group consisting of: lithium hydroxide (LiOH), lithium amide (LiNH₂), butyllithium (C₄H₉Li), and combinations thereof.

In one aspect, the contacting may include adding the lithium precursor to the porous material at a temperature greater than or equal to about 20° C. to less than or equal to about 80° C. and holding the temperature for a period greater than or equal to about 5 minutes to less than or equal to about 5 hours, and adding the aqueous solvent after the period.

In one aspect, the removing of the aqueous solvent includes a vacuum drying process having a temperature greater than or equal to about 80° C. to less than or equal to about 200° C.

In one aspect, the method may further include disposing the pre-lithiating, porous layer near or adjacent to a surface of a separator such that the pre-lithiating, porous layer forms a continuous coating on the surface of the separator.

In one aspect, the method may further include disposing the pre-lithiating, porous layer near or adjacent to a surface of an electrode such that the pre-lithiating, porous layer forms a continuous coating on the surface of the electrode.

In one aspect, the porous material may have a porosity greater than or equal to about 20 vol. % to less than or equal to about 80 vol. % and may be selected from the group consisting of: zeolites, aerogels, silicon oxides, porous aluminum oxides, titanium oxides, manganese oxides, magnesium oxides, and combinations thereof.

### BRIEF DESCRIPTION OF THE DRAWING

The drawing described herein is for illustrative purposes only of selected embodiments and not all possible implementations, and is not intended to limit the scope of the present disclosure.

FIG. 1 is a schematic of an example electrochemical battery cell including a pre-lithiating, porous layer disposed near or adjacent to a surface of the separator opposing the positive electrode in accordance with various aspects of the present disclosure.

Further areas of applicability will become apparent from the description provided herein. The description and specific examples in this summary are intended for purposes of illustration only and are not intended to limit the scope of the present disclosure.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first.” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawing.

The present technology relates to electrochemical cells including separators, where one or more surfaces of the separators are coated with a pre-lithiating, porous coating, and to methods of making and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

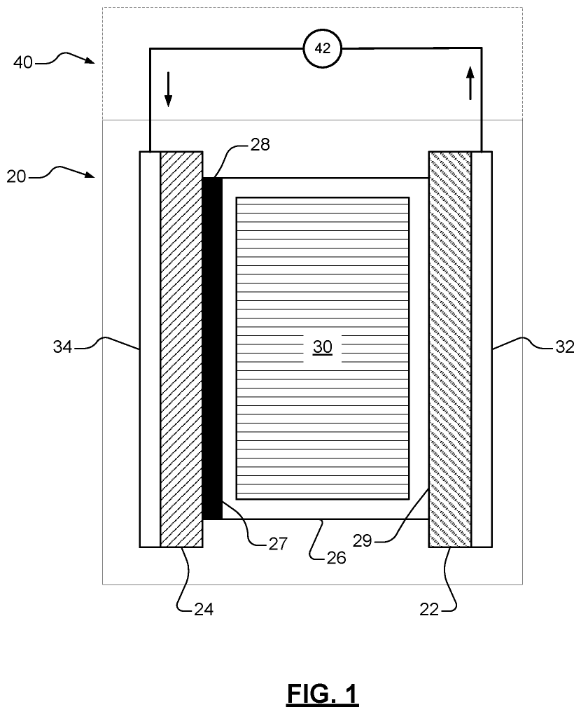

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, a porous layer 27 may be disposed near or adjacent to one or more sides of the separator 26 (including, for example, as illustrated, a side of the separator 26 opposing the positive electrode 24). The porous layer 27 may, in certain variations, as further discussed below, serve as a lithium source for pre-lithiation during formation. In each variation, the separator 26 may include an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22 (which can also be referred to as a negative electroactive material layer). The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode 24 (which can also be referred to as a positive electroactive material layer). The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material. The ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, LiOCl, Li_{2.99} Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

In various aspects, a porous layer 28 may be disposed near to adjacent to one or more sides of the separator 26 (or alternatively, the solid-state electrolyte (“SSE”) or semi-solid-state electrolyte (e.g., gel)). For example, as illustrated, a porous layer 28 may be disposed near or adjacent to a first side 27 of the separator 26 opposing the positive electrode 24. Although not illustrated, it should be appreciated at in certain variations, a first porous layer may be disposed near or adjacent to the first side 27 of the separator 26 opposing the positive electrode 24, and a second porous layer that is similar to the first porous layer may be disposed near or adjacent to a second side 29 of the separator 26 opposing the negative electrode 22.

As illustrated, the porous layer 28 may be a substantially continuous coating that covers, for example, greater than or equal to about 85%, optionally greater than or equal to about 90%, optionally greater than or equal to about 95%, optionally greater than or equal to about 98%, optionally greater than or equal to about 99%, and in certain aspects, optionally greater then or equal to about 99.5%, of a total surface area of the first side 27 of the separator 26 and/or of a total surface area of a side of the positive electrode 24 opposing the separator 26. In each instance, the porous layer 28 may have an average thickness greater than or equal to about 50 nanometers (nm) to less than or equal to about 100 μm, and in certain aspects, optionally greater than or equal to about 5 μm to less than or equal to about 30 μm.

The porous layer 28 may be defined by a porous material having a porosity greater than or equal to about 15 vol. % to less than or equal to about 90 vol. %, and in certain aspects, optionally greater than or equal to about 25 vol. % to less than or equal to about 50 vol. %. In certain variations, the porous material may include, for example, zeolites (such as a y-type zeolite), aerogels, silicon oxides, porous aluminum oxides, titanium oxides, manganese oxides, and/or magnesium oxides. In each instance, the porous material may be impregnated with a lithiating material, such as lithium peroxide (Li₂O₂). For example, the porous layer 28 may include greater than or equal to about 5 wt. % to less than or equal to about 90 wt. %, and in certain aspects, optionally greater than or equal to about 20 wt. % to less than or equal to about 60 wt. %, of the porous material; and greater than or equal to about 30 wt. % to less than or equal to about 50 wt. %, and in certain aspects, optionally greater than or equal to about 35 wt. % to less than or equal to about 45 wt. %, of the lithating material. The lithiating material may fills greater than or equal to about 20% to less than or equal to about 100%, and in certain aspects, optionally greater than or equal to about 30% to less than or equal to about 60% of a total porosity of the porous material.

The lithiating material may act as a lithium source for pre-lithiating during a formation cycle, which includes, for example, the first several cycles (e.g., less than 5 cycles) having slow chagrining and discharging rates. For example, during the formation cycle, the lithium peroxide may decompose, releasing lithium ions (Li⁺) and oxygen (O₂). The released lithium ions can be used for prelithiation of the negative electroactive material, while the released oxygen can be collected (for example, in the pouch cells) and released after formation cycle. Importantly because of the selection of the porous material there is no physical dimension change to the porous layer 28 upon the decomposition of the lithiation material.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. In each instance, the negative electrode 22 (including the one or more layers) may have a thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In certain variations, the negative electrode 22 may include a silicon-based negative electroactive material, including, for example lithium-silicon, silicon containing binary and ternary alloys, and/or tin-containing alloys (such as, Si, Li—Si, SiOₓ (where 0≤x≤2), lithium doped SiOₓ (where 0≤x≤2), Si—Sn, SiSnFe, SiSnAl, SiFeCo, SnO₂, and the like). In other variations, the negative electrode 22 may include one or more other volume-expanding negative electroactive materials (e.g., aluminum, germanium, tin). In still other variations, the negative electrode 22 may include a lithium-containing negative electroactive material, such as a lithium alloy and/or a lithium metal. For example, in certain variations, the negative electrode 22 may be defined by a lithium metal foil. In still other variations, the negative electrode 22 may include, for example only, carbonaceous negative electroactive materials (such as, graphite, hard carbon, soft carbon, and the like) and/or metallic active materials (such as tin, aluminum, magnesium, germanium, and alloys thereof, and the like).

In further variations, the negative electrode 22 may be a composite electrode including a combination of negative electroactive materials. For example, the negative electrode 22 may include a first negative electroactive material and a second negative electroactive material. A ratio of the first negative electroactive material to the second negative electroactive material may be greater than or equal to about 5:95 to less than or equal to about 95:5. In certain variations, the first negative electroactive material may be a volume-expanding material including, for example, silicon, aluminum, germanium, and/or tin; and the second negative electroactive material may include a carbonaceous material (e.g., graphite, hard carbon, and/or soft carbon). For example, in certain variations, the negative electroactive material may include a carbonaceous-silicon based composite including, for example, about 10 wt. % SiOₓ (where 0≤x≤2) and about 90 wt. % graphite.

In each variation, the negative electroactive material may be optionally intermingled with an electronically conductive material (i.e. conductive additive) that provide an electron conductive path and/or a polymeric binder material that improve the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electroactive material (also referred to as cathode active materials (CAM)) defining the positive electrode 24 includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof. In still further variations,

In further variations, the positive electrode 24 may be a composite electrode including a combination of positive electroactive materials. For example, the positive electrode 24 may include a first positive electroactive material and a second electroactive material. A ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxide, one or more tavorite, or combinations thereof.

In each variation, the positive electroactive material may also be optionally intermingled with an electronically conductive material (i.e. conductive additive) that provide an electron conductive path and/or a polymeric binder material that improve the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The conductive additive and/or binder material as included in the positive electrode 24 may be the same as or different from the conductive additive as included in the negative electrode 22.

In various aspects, the present disclosure provides methods for preparing pre-lithiating, porous layer, like the porous layer 28 illustrated in FIG. 1. In certain variations, an example method for preparing a pre-lithiating, porous separator coating may include obtaining a porous material and impregnating the porous material with the lithiating material (e.g., lithium peroxide). The porous material may be impregnated with the lithiating material using an in-situ precipitation process where the porous material is contacted with a precursor solution including a lithium-containing material and a solvent followed by the removal of the solvent, for example, using a vacuum drying process, which induces precipitation. For example, the pores of the porous material may be at least partially filled with the precursor solution and upon removal of the solvent the precipitate may remain in the pores of the porous material. The lithium-containing material may include, for example, lithium hydroxide (LiOH), lithium amide (LiNH₂), and/or butyllithium (C₄H₉Li), while the solvent is an aqueous solvent. In certain variation, the precipitation may be represented by 2 LiOH+H₂O₂→Li₂O₂ ↓+2 H₂O. In other variations, the precipitation may be represented by LiNH₂+H₂O₂→Li₂O₂↓+NH₃. In still other variations, the precipitation may be represented by C₄H₉Li+H₂O₂→Li₂O₂↓+C₄H₁₀. In each instance, the method may further include, following the precipitating, disposing the porous layer onto or near the one or more surfaces of the separator and/or aligning the coated separator with electrodes to assemble the cell. Alternatively, the method may further include, following the precipitating, disposing the porous layer onto or near a surface of a surface of a positive electrode that will oppose the separator and/or aligning the positive electrode with a separator and a negative electrode to assemble the cell. In each instance, the method may also further include, after cell assembly, initiating a formation cycle (e.g., 4.3 V).

In other variations, an example method for preparing a pre-lithiating, porous layer may include obtaining a porous material (e.g., zeolite, aerogel, silica) and impregnating the porous material with the lithiating material (e.g., lithium peroxide) by contacting the porous material with a lithium-containing solution (for example, adding the lithium-containing solution to the porous material and maintaining) at a temperature greater than or equal to about 0° C. to less than or equal to about 100° C., and in certain aspects, optionally greater than or equal to about 40° C. to less than or equal to about 80° C., for a period greater than or equal to about 5 minutes to less than or equal to about 24 hours, and in certain aspects, optionally greater than or equal to about 1 hour to less than or equal to about 5 hours, and subsequently, contacting (e.g., adding) an aqueous solution to the porous material including the lithium-containing solution and removing the solvent, for example, using a vacuum drying process, to induce precipitation. For example, in certain variation, the lithium-containing solution may include lithium hydroxide, and the precipitation may be represented by 2 LiOH+H₂O₂→Li₂O₂ ↓+2 H₂O. In other variations, the precipitation may be represented by LiNH₂+H₂O₂→Li₂O₂↓+NH₃. In still other variations, the precipitation may be represented by C₄H₉Li+H₂O₂→Li₂O₂↓+C₄H₁₀. In each instance, the method may further include, following the precipitating, disposing the porous layer onto the one or more surfaces of the separator and/or aligning the coated separator with electrodes to assemble the cell. Alternatively, the method may further include, following the precipitating, disposing the porous layer onto a surface of a positive electrode that will oppose the separator and/or aligning the positive electrode with a separator and a negative electrode to assemble the cell. In each instance, the method may also further include, after cell assembly, initiating a formation cycle (e.g., 4.3 V).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical cell that cycles lithium ions, the electrochemical cell comprising:
a first electrode comprising a positive electroactive material;
a second electrode comprising a negative electroactive material;
a separating layer physically separating the first electrode and the second electrode; and
a porous layer disposed between the separating layer and the first electrode, the porous layer comprising a porous material having a plurality of pores and a lithiating material at least partially filling the pores of the plurality.

2. The electrochemical cell of claim 1, wherein the porous layer is a continuous coating disposed on a surface of the separating layer opposing the first electrode.

3. The electrochemical cell of claim 1, wherein the porous layer is a continuous coating disposed on a surface of the first electrode opposing the separating layer.

4. The electrochemical cell of claim 1, wherein the porous material has a porosity greater than or equal to about 5 vol. % to less than or equal to about 90 vol. %, and the lithiating material fills greater than or equal to about 30% to less than or equal to about 60% of the porosity of the porous material.

5. The electrochemical cell of claim 4, wherein the porous material is selected from the group consisting of: zeolites, aerogels, silicon oxides, porous aluminum oxides, titanium oxides, manganese oxides, magnesium oxides, and combinations thereof.

6. The electrochemical cell of claim 1, wherein the lithiating material comprise lithium peroxide (Li₂O₂).

7. The electrochemical cell of claim 1, wherein the porous layer has an average thickness greater than or equal to about 50 nanometers to less than or equal to about 50 micrometers.

8. An electrochemical cell that cycles lithium ions, the electrochemical cell comprising:
a first electrode comprising a positive electroactive material;
a second electrode comprising a negative electroactive material;
a separating layer physically separating the first electrode and the second electrode; and
a porous layer disposed between the separating layer and the first electrode, the porous layer comprising a porous material having a plurality of pores and a porosity of greater than or equal to about 20 vol. % to less than or equal to about 100 vol. % and a lithiating material comprising lithium peroxide (Li₂O₂) at least partially filling the plurality of pores.

9. The electrochemical cell of claim 8, wherein the porous layer is a continuous coating disposed on a surface of the separating layer opposing the first electrode.

10. The electrochemical cell of claim 8, wherein the porous layer is a continuous coating disposed on a surface of the first electrode opposing the separating layer.

11. The electrochemical cell of claim 8, wherein the lithiating material fills greater than or equal to about 30% to less than or equal to about 60% of the porosity of the porous material.

12. The electrochemical cell of claim 8, wherein the porous material is selected from the group consisting of: zeolites, aerogels, silicon oxides, porous aluminum oxides, titanium oxides, manganese oxides, magnesium oxides, and combinations thereof.

13. The electrochemical cell of claim 8, wherein the porous layer has an average thickness greater than or equal to about 50 nanometers to less than or equal to about 50 micrometers.

14. A method for preparing a pre-lithiating, porous layer for an electrochemical cell that cycles lithium ions, the method comprising:
contacting a porous material having a plurality of pores and a precursor solution including a lithium precursor and an aqueous solvent such that the precursor solution at least partially fills the plurality of pores; and
removing the aqueous solvent so as to form a lithiated precipitate in at least a portion of the plurality of pores to form the pre-lithiating, porous layer.

15. The method of claim 14, wherein the lithium precursor is selected from the group consisting of: lithium hydroxide (LiOH), lithium amide (LiNH₂), butyllithium (C₄H₉Li), and combinations thereof.

16. The method of claim 14, wherein the contacting comprises:
adding the lithium precursor to the porous material at a temperature greater than or equal to about 20° C. to less than or equal to about 80° C. and holding the temperature for a period greater than or equal to about 5 minutes to less than or equal to about 5 hours; and
adding the aqueous solvent after the period.

17. The method of claim 14, wherein the removing of the aqueous solvent comprises a vacuum drying process having a temperature greater than or equal to about 80° C. to less than or equal to about 200° C.

18. The method of claim 14, wherein the method further comprises:
disposing the pre-lithiating, porous layer near or adjacent to a surface of a separator such that the pre-lithiating, porous layer forms a continuous coating on the surface of the separator.

19. The method of claim 14, wherein the method further comprises:
disposing the pre-lithiating, porous layer near or adjacent to a surface of an electrode such that the pre-lithiating, porous layer forms a continuous coating on the surface of the electrode.

20. The method of claim 14, wherein the porous material has a porosity greater than or equal to about 20 vol. % to less than or equal to about 80 vol. % and is selected from the group consisting of: zeolites, aerogels, silicon oxides, porous aluminum oxides, titanium oxides, manganese oxides, magnesium oxides, and combinations thereof.
